(19) United States
(12) Patent Application Publication
(10) Pub. No.: US 2024/0391541 A1
(43) Pub. Date: Nov. 28, 2024

(54) TRACKED VEHICLE

(71) Applicant: Kässbohrer Geländefahrzeug AG, Laupheim (DE)

(72) Inventors: Roman Ströbele, Staig (DE); Patrick Bröckel, Heroldstatt (DE); Stefan Hecht, Tiefenbach (DE); Christian Reger, Ehingen (DE)

(21) Appl. No.: 18/324,067

(22) Filed: May 25, 2023

(51) Int. Cl. B62D 55/06; B60J 1/02; B60K 11/08; B60K 15/04; B62D 33/06; B62D 55/12; B62D 55/14

(52) U.S. Cl. CPC B62D 55/06; B60J 1/02; B60K 11/08; B60K 15/04; B62D 33/0617; B62D 55/12; B62D 55/14

(57) ABSTRACT

A tracked vehicle is herein provided. In one example, a tracked vehicle comprises a chassis extending along a longitudinal direction of the tracked vehicle, wherein the chassis comprises a plurality of frame members extending along the longitudinal direction; an operator cabin coupled to the chassis; a power unit comprising a prime mover coupled to the chassis and housed within a power unit housing that comprises a plurality of service doors, wherein the power unit housing comprises a side portion and a back portion, wherein a front section of the side portion is configured with a downsloping angle; and a pair of track assemblies coupled to the plurality of frame members, wherein each track assembly comprises an endless track disposed around a plurality of wheels.

### TECHNICAL FIELD

Embodiments of the subject matter disclosed herein relate to a tracked vehicle.

### BACKGROUND AND SUMMARY

Tracked vehicles, e.g., crawler vehicles, are well known vehicles used for a variety of applications, including grooming of ski slopes, carrying of work equipment, in construction, and in other transportation applications. Such vehicles are often configured to travel on various terrains, including rugged terrain with mud, steep hills, swamps, rocks, and/or snow.

Such tracked vehicles often comprise a power unit that includes a prime mover such as an internal combustion engine and a plurality of related components configured to support the prime mover. The related components, including fluid tanks (e.g., hydraulic oil tanks, wiper fluid tanks, etc.), filters, electrical components, and the like, may require period servicing and/or maintenance for repairs, replacement, and/or refills.

Steben et al (U.S. Pat. No. 10,384,732B2) teaches an example of a tracked vehicle as herein discussed. The tracked vehicle of Steben's design includes a power plant housed within a housing. A plurality of power plant components, including a prime mover, a hydraulic pump and drive system, a cooling reservoir, fluid reservoirs, and a battery system are housed within the power plant housing. As is described by Steben et al, access to the housing is facilitated by the housing being mounted atop a chassis of the tracked vehicle. However, access to the components of the power plant may demand disassembling at least a portion of the housing, which increases time spent during maintenance and/or service of components of the power plant.

Further, tracked vehicles comprise a station for an operator, such as an operator cabin, from which the operator may operate the tracked vehicle. Such operator stations often are enclosed and include one or more windows (e.g., windshields) through which the operator may view surroundings including terrain, objects, and/or persons while sitting in the operator station. In some examples of tracked vehicles, portions of a field of view of the operator may be reduced as a result of components of the tracked vehicle such as an engine enclosure (e.g., a power unit housing) being positioned such as to partially obstruct the field of view.

The inventors herein have recognized the aforementioned issues and developed a tracked vehicle that at least partially addresses these issues. The tracked vehicle comprises, in one example, a power unit housed within a housing that includes a plurality of service doors. Each of the plurality of service doors allows access to a respective subset of components of the power unit, including a first subset of components accessible from a first service door, a second subset of components accessible from a second service door, and a third subset of components accessible from a third service door. Each of the first, second, and third subsets of components of the power unit are arranged to increase efficiency of service and maintenance tasks, including grouping components in different subsets based on functionality and design so as to support a prime mover as well as fit within a package of a respective section of the housing. In some examples, the first subset of components comprises a plurality of refueling components such as a plurality of filler necks for various fluid tanks, as well as a plurality of electrical components; the second subset of components comprises a plurality of filters; and the third subset of components comprises one or more cooling system components such as a condenser and a combination cooler. In this way, components that demand frequent, sometimes daily, servicing and/or maintenance are more easily accessible via the plurality of service doors.

The housing of the power unit comprises a back portion and a side portion, the side portion being partitioned into a front section, a rear section, and a middle section positioned between the front and rear sections. The front section of the housing is configured with a downsloping angle such that a height of a front end of the front section is lower than a height of a rear end of the front section. The downsloping angle at the front of the enclosure allows for an increased size of a lateral facing aspect of a windshield of an operator cabin, thereby increasing a lateral field of view of the operator. Further, a front facing aspect of the windshield extends further down to a height lower than the height of the front end of the front section of the enclosure. In this way, a front facing field of view of the operator is further increased by increasing a depth angle of the field of view. The increased lateral field of view and front facing field of view allows the operator to more readily view objects, persons, and terrain.

Further, the first section of the side portion of the housing comprises a cutout that includes a recessed portion along a transverse direction that allows access to the first subset of components from above when the first service door is open. The first service door of the housing is configured as an irregular shape to cover a cutout of the front section of the housing when the first service door is closed. Access from above may further increase efficiency of access to the first subset of components during maintenance and/or service.

It should be understood that the brief description above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

FIG. 1 shows a tracked vehicle in accordance with the present disclosure.

FIG. 2 shows the tracked vehicle with work equipment positioned atop a chassis of the tracked vehicle.

FIG. 3 shows the tracked vehicle with components of a power unit exposed.

FIG. 4 shows the tracked vehicle with components of the power unit exposed.

FIG. 5 shows a first subset of components of the power unit accessible via a first service door of the power unit housing in an open configuration.

FIG. 6 shows a top down view of the tracked vehicle with the first service door of the power unit in the open configuration.

FIG. 7 shows the tracked vehicle with a second service door of the power unit in an open configuration.

FIG. 8 shows a second subset of components of the power unit accessible via the second service door in the open configuration.

FIG. 9 shows a third subset of components of the power unit of the tracked vehicle accessible via a third service door in an open configuration.

FIG. 10 shows ribs of the third service door of the power unit of the tracked vehicle.

FIG. 11 shows electrical components of the power unit of the tracked vehicle.

FIG. 12 shows a downsloping angle of a front section of an enclosure of the power unit of the tracked vehicle.

FIG. 13A shows a front facing field of view of an operator from a first lateral side of the tracked vehicle.

FIG. 13B shows the front facing field of view of the operator from a second lateral side of the tracked vehicle.

FIG. 14 shows a first lateral field of view from a front end of the tracked vehicle.

FIG. 15 shows a second lateral field of view from the front end of the tracked vehicle.

### DETAILED DESCRIPTION

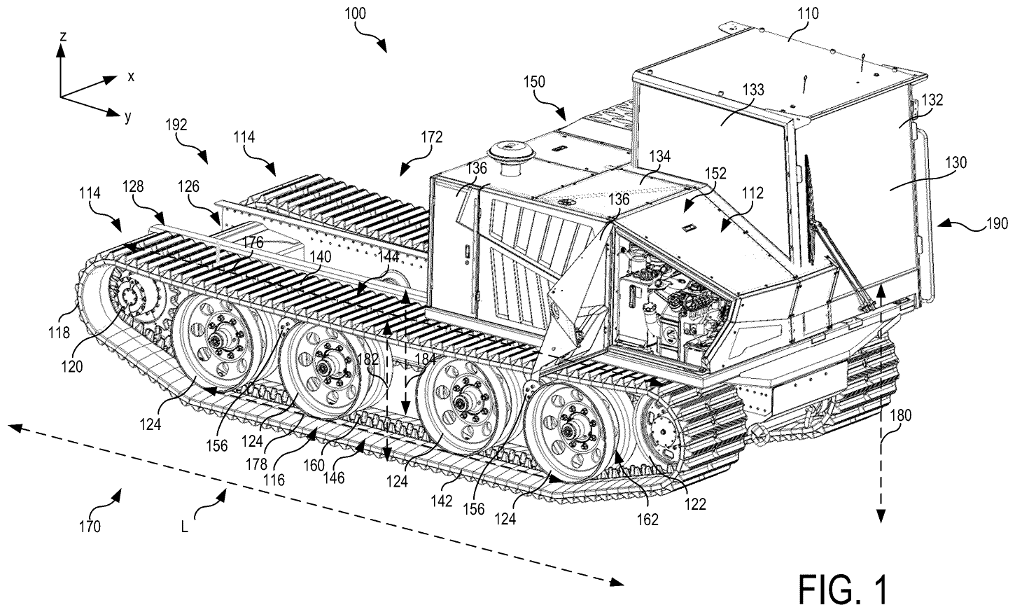

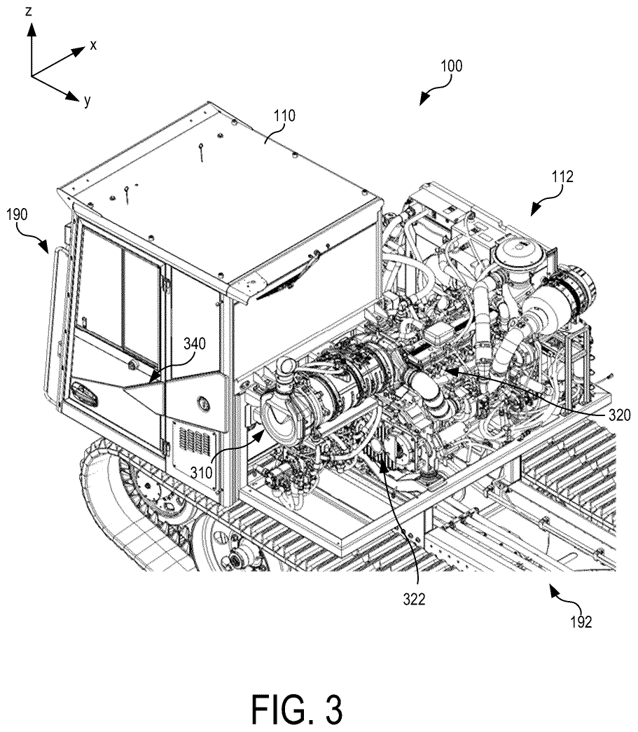

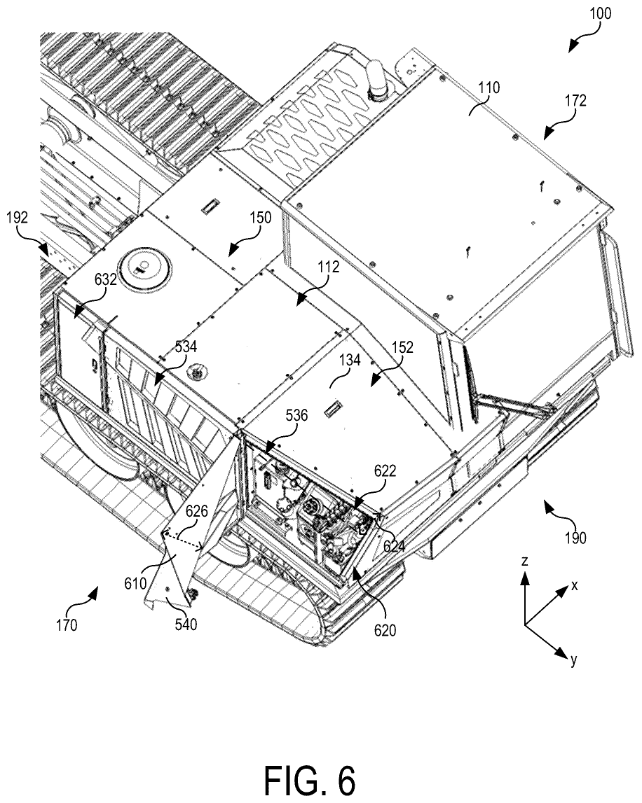

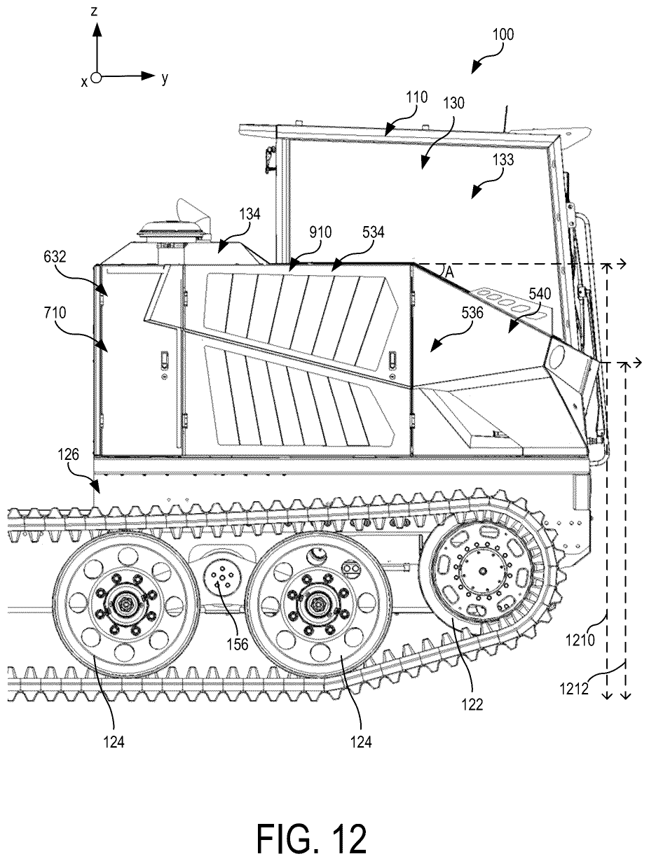

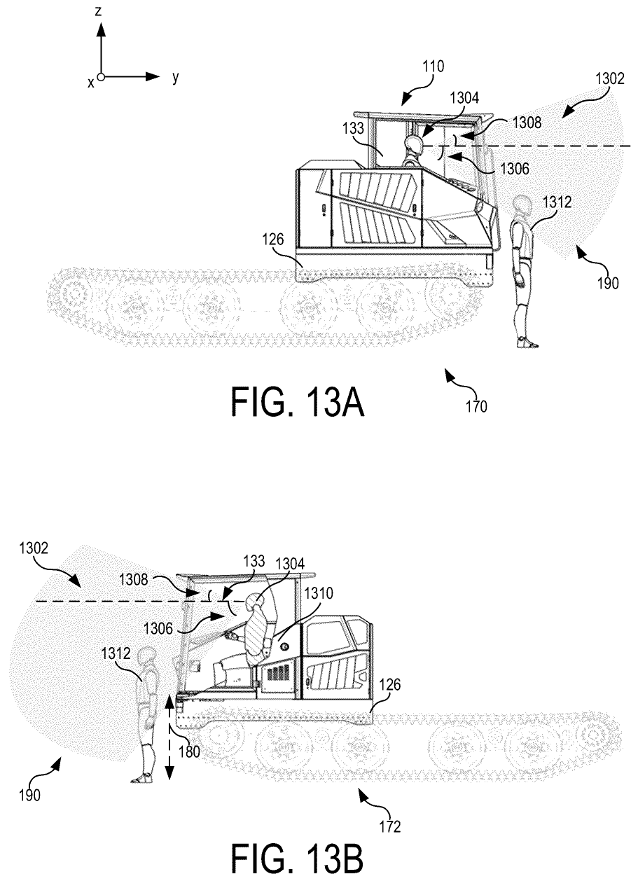

The following description relates to systems for a tracked vehicle. The tracked vehicle of the present disclosure is shown in FIGS. 1, 2, 7, and 9. The tracked vehicle includes a power unit housed within a housing. Components included within the power unit, including a prime mover, electrical components, fluid ports (e.g., filler necks), and more, are shown in FIGS. 3, 4, 5, 8, 11, and 12. A plurality of service doors configured to allow to access components of the power unit are shown in FIGS. 6, 7, and 9. Various aspects of a field of view of an operator of the tracked vehicle provided at least in part by a downsloping angle of a front end of the enclosure of the power unit, as shown in FIG. 12, is shown in FIGS. 13A, 13B, 14, and 15.

FIGS. 1-15 show example configurations with relative positioning of the various components. If shown directly contacting each other, or directly coupled, then such elements may be referred to as directly contacting or directly coupled, respectively, at least in one example. Similarly, elements shown contiguous or adjacent to one another may be contiguous or adjacent to each other, respectively, at least in one example. As an example, components laying in face-sharing contact with each other may be referred to as in face-sharing contact. As another example, elements positioned apart from each other with only a space there-between and no other components may be referred to as such, in at least one example. As yet another example, elements shown above/below one another, at opposite sides to one another, or to the left/right of one another may be referred to as such, relative to one another. Further, as shown in the figures, a topmost element or point of element may be referred to as a “top” of the component and a bottommost element or point of the element may be referred to as a “bottom” of the component, in at least one example. As used herein, top/bottom, upper/lower, above/below, may be relative to a vertical axis of the figures and used to describe positioning of elements of the figures relative to one another. As such, elements shown above other elements are positioned vertically above the other elements, in one example. As yet another example, shapes of the elements depicted within the figures may be referred to as having those shapes (e.g., such as being circular, straight, planar, curved, rounded, chamfered, angled, or the like). Further, elements shown intersecting one another may be referred to as intersecting elements or intersecting one another, in at least one example. Further still, an element shown within another element or shown outside of another element may be referred as such, in one example.

Turning to FIG. 1, a tracked vehicle 100 is shown. Tracked vehicle 100 may be a tracked utility vehicle configured for one or more of a variety of applications, including carrying work equipment such as a dumper, construction applications, and the like. The tracked vehicle 100 may include, in some examples, an operator cabin 110 and a power unit 112 both mounted to and positioned directly atop a chassis 126. The tracked vehicle 100 may have a length L in a longitudinal direction and the chassis 126 extends along length L of the tracked vehicle 100. The longitudinal direction of the tracked vehicle 100 may be aligned with (e.g., parallel to) a longitudinal axis. A coordinate system is provided for reference in FIGS. 1-15. A y-axis of the coordinate system may correspond to the longitudinal direction of the tracked vehicle, an x-axis of the coordinate system may correspond to the transverse direction of the tracked vehicle, and a z-axis of the coordinate system may be a vertical axis (e.g., a gravitational axis).

The power unit 112 may comprise a prime mover (e.g., an internal combustion engine, a traction motor, an electric machine, etc.), a hydraulic system, a battery system, a plurality of filler necks for various fluid tanks, and a plurality of electrical components. Each of the components within the power unit 112 may be housed within a power unit housing 134 (e.g., an enclosure) that is mounted to or otherwise coupled to a top surface of the chassis 126. The power unit housing 134 may comprise a back portion 150 located directly behind (e.g., behind the rear end 192 of) the operator cabin 110 and a side portion 152 located on a side of the operator cabin 110. The side portion 152 may be positioned directly next to the operator cabin 110 such that a second lateral side 172 of the side portion 152 of the power unit housing 134 is in face sharing contact with a first lateral side 170 of the operator cabin 110. As noted, the power unit 112 may further extend behind the operator cabin 110 via the back portion 150, and thus the power unit 112 and the power unit housing 134 are configured as generally L-shaped.

The power unit 112 and the components therein may be configured to generate power to move the tracked vehicle 100 and as such may be in a driving relationship with each of a pair of track assemblies 114. Power from the power unit 112 may be transmitted to the pair of track assemblies 114 via a hydraulic drive system that comprises a hydraulic pump driven by the prime mover and connected to a hydraulic motor, though power may be transmitted in various other ways in other embodiments.

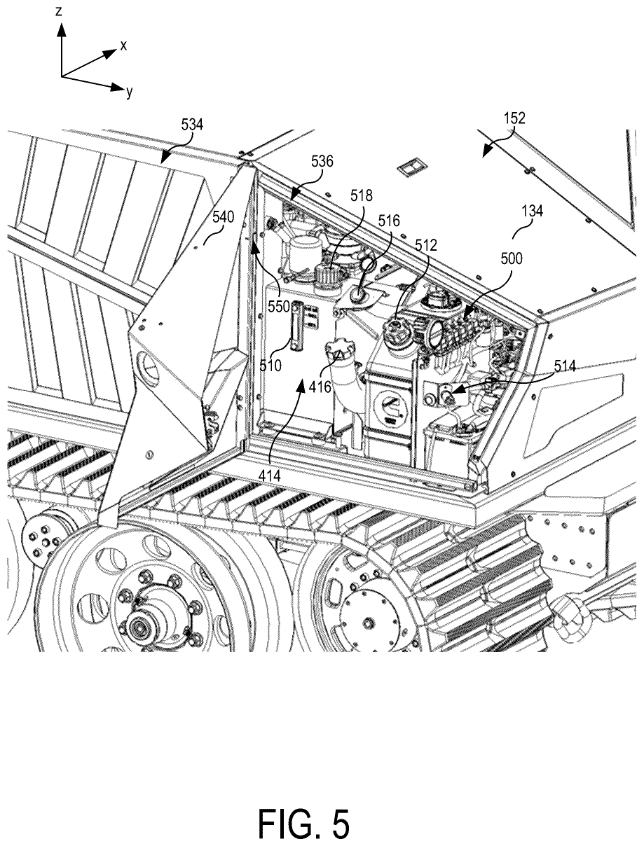

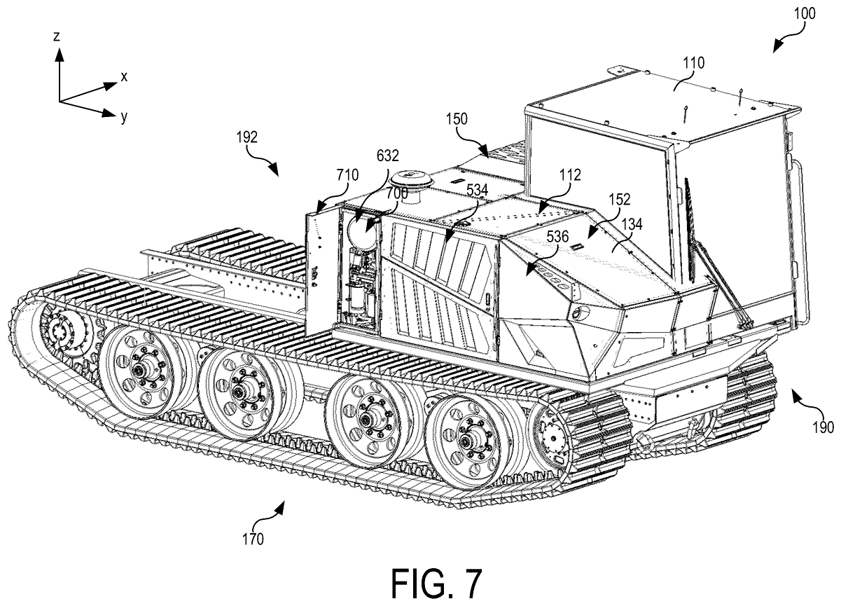

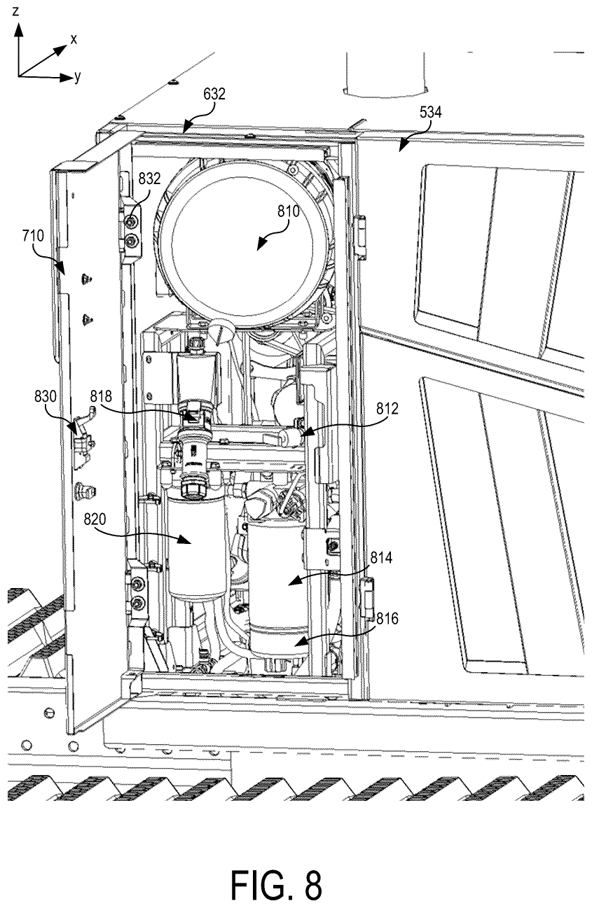

The power unit housing 134 may comprise a plurality of service doors 136 positioned on the first lateral side 170 of the side portion 152 of the power unit housing 134. Each of the plurality of service doors 136, when in an open configuration, allow access to a respective subset of components of the power unit 112. Each of the plurality of service doors 136 may allow access to a different subset of components of the power unit 112 and components may be grouped into respective subsets based on functionality and design. For example, a filter service door, as will be later described with reference to FIGS. 7 and 8, may allow access to a plurality of filter elements while a refueling service door, as will be described with reference to FIGS. 5 and 6, may allow access to the plurality of filler necks. In this way, components that comprise fluid tanks with filler necks may be grouped together to be accessed from a single service door/access panel while components that comprise exchangeable/replaceable filters may be grouped together to be accessed from a second single service door/access panel. Additionally, components included in a respective subset of components may be arranged so as to fit within a package of a respective section of the power unit housing 134.

Further, mounting of the power unit housing 134 and the components of the power unit 112 above the chassis 126 may facilitate installation and service of components of the power unit 112. For example, maintenance or other servicing activities may be performed by accessing components of the power unit 112 via one or more of the plurality of service doors 136 without being obstructed by the operator cabin 110 or other components (such as work equipment mounted to the chassis 126).

In some examples, the operator cabin 110 comprises a seat with a single seat position for an operator (e.g., operator 1304 shown in FIGS. 13A-15) to sit when operating the tracked vehicle 100. The operator cabin 110 further comprises a windshield 130 that spans a front facing aspect 132 as well as a plurality of lateral facing aspects 133. A first lateral facing aspect may be positioned on the first lateral side 170 and a second lateral facing aspect may be positioned on the second lateral side 172. The windshield 130 may allow the operator of the tracked vehicle 100 to view objects (persons, obstructions, terrain, etc.) in front of the tracked vehicle 100 and to the sides of the tracked vehicle 100. A bottom edge of the front facing aspect 132 of the windshield 130 may have a height 180 from the ground. Further, the bottom edge of the front facing aspect 132 may be closer to the ground than a top surface of the power unit housing 134. Field of views of the operator provided by the windshield 130 are described in greater detail with respect to FIGS. 13A-15.

In some examples, the chassis 126 comprises a frame that comprises a plurality of frame members 128 extending along length L of the tracked vehicle. A first frame member may be positioned on the first lateral side 170 and the second frame member may be positioned on a second lateral side 172, the second lateral side 172 being opposite the first lateral side 170 in a transverse direction of the tracked vehicle 100. The operator cabin 110 may be positioned atop the chassis 126 such that a front end 190 of the operator cabin 110 is in line with the front end 190 of each of the plurality of frame members 128 and the front end 190 of the chassis 126. The front end 190 of the power unit housing 134 may also be in line with the front end 190 of the operator cabin 110. Each of the plurality of frame members 128 may couple to and support one of the pair of track assemblies 114.

The pair of track assemblies 114 may be configured to provide traction of the tracked vehicle 100 when in contact with a ground surface. A first track assembly of the pair of track assemblies 114 may be positioned on the first lateral side 170 (e.g., a right side) of the tracked vehicle 100, coupled to the first frame member, and a second track assembly of the pair of track assemblies 114 may be positioned on the second lateral side 172 (e.g., a left side) of the tracked vehicle 100, coupled to the second frame member. The first of the pair of track assemblies 114 may be a mirror of the second of the pair of track assemblies 114.

Each of the pair of track assemblies 114 may comprise an endless track 118 disposed around a plurality of wheels 116. The plurality of wheels 116 may comprise an end wheel 120, a drive wheel 122, and a plurality of support wheels 124. In some examples, the end wheel 120 may be positioned further towards a rear of the tracked vehicle 100, along a longitudinal direction, than the drive wheel 122. The end wheel 120 may be spaced apart from the drive wheel 122 and the plurality of support wheels 124 may be positioned between the end wheel 120 and the drive wheel 122 in the longitudinal direction of the tracked vehicle 100. The end wheel 120 may also be spaced apart from a rearmost support wheel of the plurality of support wheels 124 and the drive wheel 122 may be spaced apart from a foremost support wheel of the plurality of support wheels 124 such that the end wheel 120 does not overlap with any of the plurality of support wheels 124 and the drive wheel 122 does not overlap with any of the plurality of support wheels 124.

In some examples, the drive wheel 122 may be a foremost wheel of the plurality of wheels 116. The drive wheel 122 may be in a driving relationship with a prime mover of the power unit 112 to impart movement to the endless track 118 to propel the tracked vehicle 100. The drive wheel 122 may be rotatable about a central axis of rotation parallel to the transverse direction of the tracked vehicle 100. In the embodiment shown in the figures provided herein, the drive wheel 122 may be positioned towards a front of the tracked vehicle 100 and therefore a powertrain of the tracked vehicle 100 may be configured to transmit motive power of the prime mover to the front of the tracked vehicle 100. In other embodiments, the drive wheel 122 may be positioned towards a rear of the vehicle.

In some examples, the end wheel 120 may be a rearmost wheel of the plurality of wheels 116. The end wheel 120 of each of the plurality of track assemblies 114 may not convert power derived from the power unit 112 to motive force for movement of the endless track 118. The end wheel 120 and the plurality of support wheels 124 may maintain tension of the endless track 118 as it is driven by the drive wheel 122. Similar to the drive wheel 122, the end wheel 120 may be rotatable about a central axis parallel to the transverse direction of the tracked vehicle 100. Each of the plurality of support wheels 124 may also be rotatable about a respective central axis parallel to the transverse direction of the tracked vehicle 100. In some examples, the respective central axes of the plurality of support wheels 124 may be variable so as to accommodate uneven terrain.

The plurality of support wheels 124 may be carried by wheel-carrying assemblies 156 (e.g., bogies). Each of the wheel-carrying assemblies 156 may carry at least two of the plurality of support wheels 124. Each of the wheel-carrying assemblies 156 may comprise a connecting structure and a pivot. The pivot may define a pivot axis for a respective wheel-carrying assembly and respective support wheels may be coupled to the connecting structure of a respective wheel-carrying assembly. Pivoting of a respective wheel-carrying assembly may alter positions of central axes of corresponding support wheels. Each of the wheel-carrying assemblies 156 may be coupled to one of the frame members 128, thereby coupling respective track assemblies to one of the frame members 128.

A top run 140 of the endless track 118 may span a first distance 176 from the end wheel 120 to the drive wheel 122 and may be positioned over and in contact with the plurality of support wheels 124. A bottom run 142 of the endless track 118 may span a second distance 178 between the rearmost support wheel and the foremost support wheel. The bottom run 142 may be in contact with the ground surface, whereby an outer surface 144 of the endless track 118 is configured to engage the ground surface and provide traction between the track assembly and the ground surface. The outer surface 144 may comprise a tread pattern configured to increase traction of the endless track 118 with the ground surface.

An inner surface 146 of the endless track 118 may be in contact with each of the plurality of wheels 116 and as such, the inner surface 146 of the top run 140 may be in contact with each of the plurality of support wheels 124. In some examples, the inner surface 146 may comprise a plurality of teeth 160 configured to fit within guiding spaces 162 of each of the plurality of support wheels 124. The plurality of teeth 160 and the guiding spaces 162 may allow the plurality of wheels 116 to remain in contact with the endless track 118 in a particular position.

The top run 140 and the bottom run 142 may be generally parallel to each other and may extend along the longitudinal direction of the tracked vehicle 100. In some examples, a height 182 of the top run 140 of the endless track 118 (measured from the ground surface) may be greater than a height 184 (measured from the ground surface) of a top surface of each of the plurality of frame members 128 such that a top surface of the top run 140 is vertically above the top surface of each of the plurality of frame members 128.

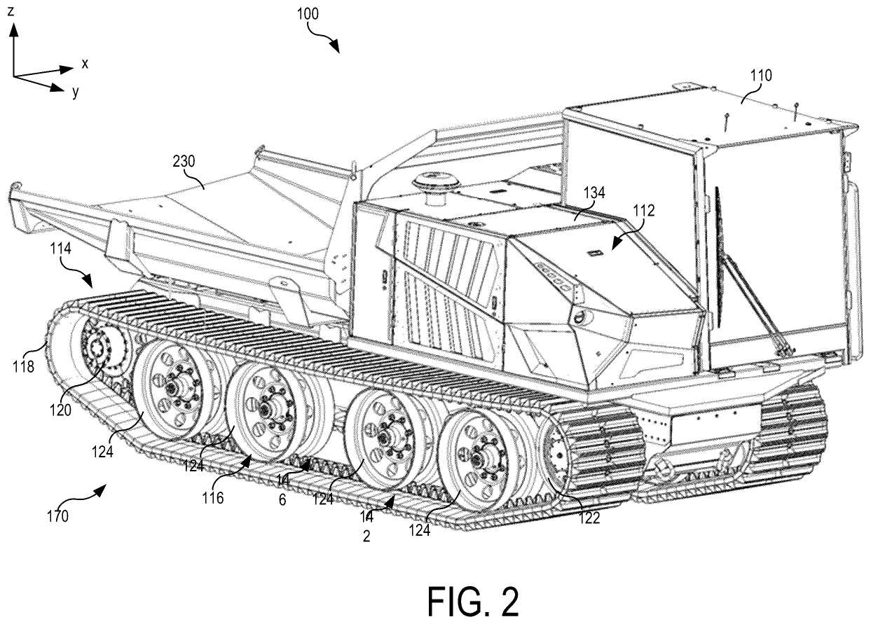

The chassis 126, including the plurality of frame members 128, may be configured to receive work equipment, such as a dumper or a loader. As shown in FIG. 2, work equipment 230 may be positioned atop and removably coupled to the chassis 126. In some examples, rotation, translation, and/or other movement of the work equipment 230 may be powered by the prime mover, in some examples. In other examples, a different power source may provide motive power to components of the work equipment 230. The tracked vehicle 100 may have a payload capacity great enough to enable use of the work equipment 230 in any reasonable fashion.

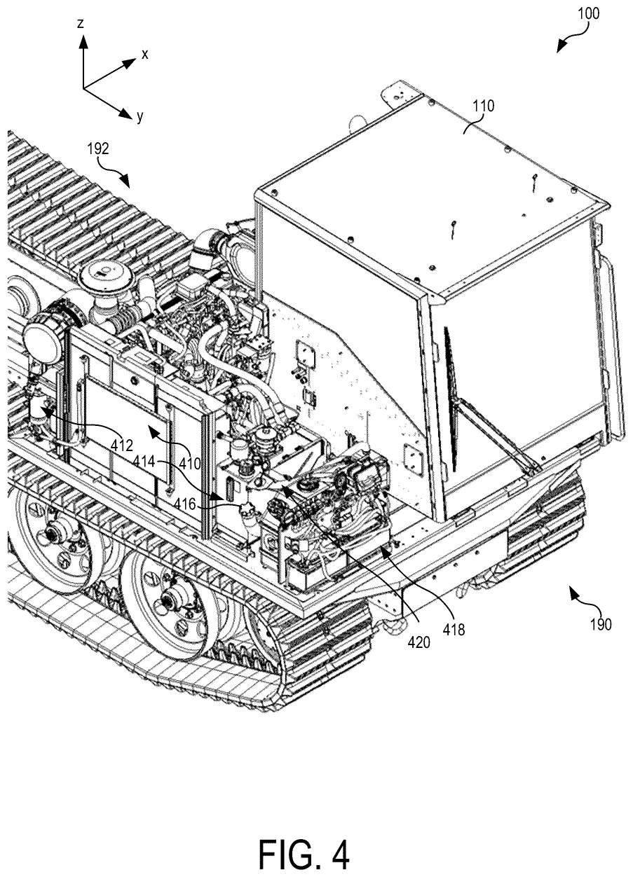

Turning now to FIGS. 3 and 4, an exposed view of the power unit 112 of the tracked vehicle 100 is shown. FIG. 3 specifically shows a rear perspective view of the power unit 112, depicting components within the back portion 150 of the power unit housing 134 while FIG. 4 shows a front perspective view of the power unit 112, depicting components within the side portion 152 of the power unit housing 134. As discussed with reference to FIG. 1, the power unit 112 is generally L-shaped positioned to the first lateral side of and behind the operator cabin 110. The operator cabin 110 further comprises a door 340 on the second lateral side 172 through which an interior of the cabin may be accessed.

The power unit 112, in some examples, comprises a prime mover 320. The prime mover 320 may be an internal combustion engine, a diesel engine, a traction motor, an electric machine, or other type of prime mover configured to provide motive power to the tracked vehicle 100. The power unit further comprises a plurality of electrical components, hydraulic system components, fluid tanks, filler necks, and the like configured to support the prime mover 320. The components may be grouped and arranged within the power unit housing 134 in a way to support the prime mover 320 while fitting within the package of the power unit housing 134. Further, a portion of the components may be arranged in respective subsets as described above to be accessed from at least one service door of the power unit housing 134. Grouping of subsets may be based on component functionality and design and/or dimensions, whereby similar components, such as filter components, are grouped together and included in the same subset to increase ease of access and efficiency during service processes.

As an example, an exhaust aftertreatment system 310 and a splitter box 322 are included in the power unit 112. The exhaust aftertreatment system 310 may regulate and/or clean exhaust emissions from the prime mover 320 to increase longevity of the prime mover 320 and by extension the tracked vehicle. The splitter box 322 may include one or more mounted hydraulic pumps and an output to aid in setup and installation. In this way, the exhaust aftertreatment system 310 and the splitter box 322, as with other components of the power unit 112, are configured to support the prime mover 320 and are positioned in relation to the prime mover 320 in order to execute their respective functions.

In some examples, components of the power unit 112 that demand relatively close proximity to the prime mover 320 may be positioned within the back portion 150. For example, a starter 330 and a turbo charger 328 may be positioned in the back portion 150. Other components of the power unit 112 may be positioned further from the prime mover 320, for example towards the first lateral side 170 so as to be accessed from one of the plurality of service doors 136. For example, an air intake 318 with an air filter 324 may be positioned towards the first lateral side 172 to be accessed via one of the plurality of service doors 136.

Some components of the power unit 112 may be positioned and/or arranged to couple between other components. As an example, a charge air pipe 326 may couple from, for example, a portion of a cooling system to the prime mover 320. In this way, the charge air pipe 326 may be configured to span from the side portion 152 of the power unit 112 to the back portion 150. As another example, hydraulic drive pumps 312 and hydraulic pumps 314 for track tensioning and/or fan drives may be configured and arranged to couple to the prime mover 320 and to other hydraulic system components. A power take off (PTO) 332 may also be include in the power unit 112 to allow for accessory attachments such as pumps to be coupled to the system.

Further, some components of the power unit 112 may be arranged to a particular vertical height within the power unit 112 and/or the power unit housing 134. For example, an intake hood 316 may be positioned so as to extend through and/or be formed as a part of the power unit housing 134 above other components of the power unit 112.

As another example, as seen in FIG. 4, additional components of the power unit 112 may be included, including a cooling system 410, filter cartridges 412, a hydraulic oil tank 414, a filler neck 416 for a diesel tank, a battery system 418, and a diesel exhaust fluid tank 420. In some examples, the cooling system 410, filter cartridges 412, the hydraulic oil tank 414, the filler neck 416, the battery system 418, and the diesel exhaust fluid tank 420 may each be accessible from external to the power unit housing 134 via a respective service door. Each of these components may be arranged within the power unit 112 so as to be accessed via the respective service door. For example, the hydraulic oil tank 414 and the battery system 418 may be positioned in front of the cooling system 410 along the longitudinal direction. In this way, the hydraulic oil tank 414 and battery system 418 may be accessed via a first service door and the cooling system 410 may be accessed via a second service door positioned behind the first service door in the longitudinal direction. In this way, routine maintenance, including oil changes, fluid refills, component replacements, and the like, may be accomplished in a more time efficient and effort efficient manner by reducing complexity of access.

In some examples, components of the power unit 112, including the components described above, may be secured to one another to form a module that can be installed on and removable from the chassis 126 together as a unit. Further, in some examples, each of the components may be individually removable from the power unit 112 for maintenance, service, and/or replacement. The components of the power unit 112 as herein described may be arranged in a configuration such that the front end 190 of the power unit 112 has a smaller height than a rear end 192 of the power unit 112, as will be further described with respect to FIG. 12.

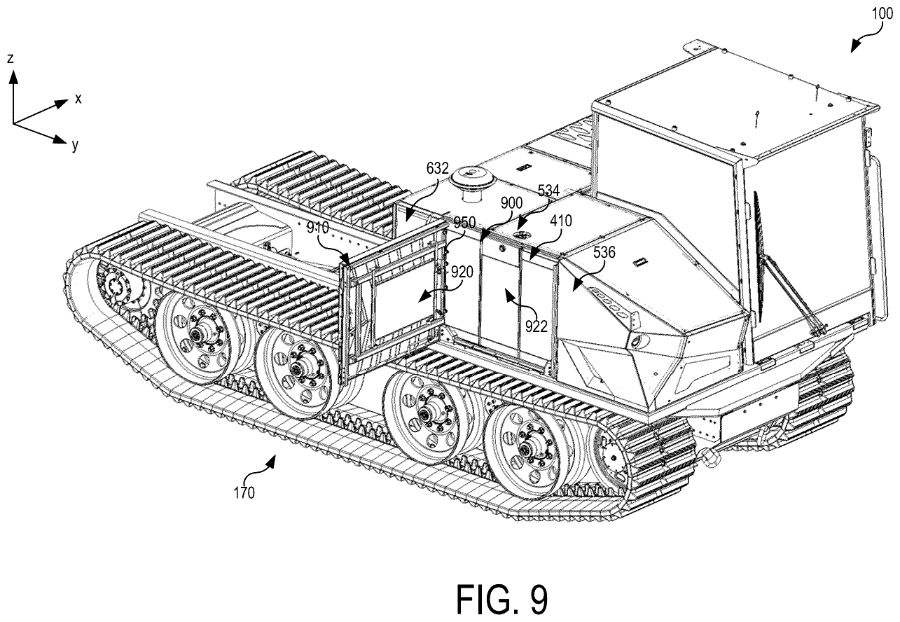

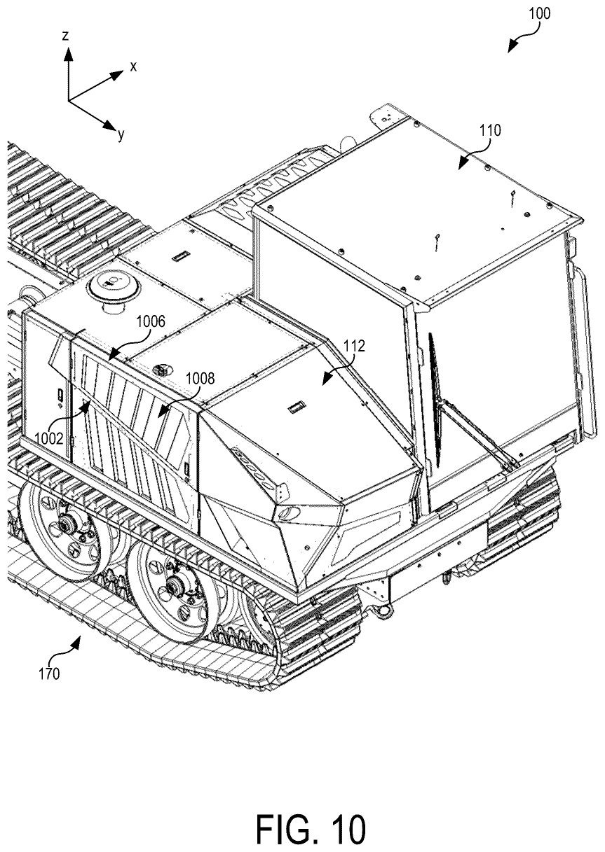

FIGS. 5-10 each show at least one of the plurality of service doors 136. FIGS. 5 and 6 show a first service door 540, FIGS. 7 and 8 show a second service door 710, and FIGS. 9 and 10 shows a third service door 910. In some examples, the side portion 152 of the power unit housing 134 may be partitioned into three sections: a front section 536, a middle section 534, and a rear section 632. The front section 536 may comprise the first service door 540, the rear section 632 may comprise the second service door 710, and the middle section 534 may comprise the third service door 910. In some examples, the first service door 540 may be a refueling service door, the second service door 710 may be a filter service door, and the third service door 910 may be a cooling system service door.

The first service door 540 may be a part of the side portion 152 of the power unit housing 134 positioned lateral to the operator cabin 110. The first service door 540 may be positioned on the first lateral side 170 of the tracked vehicle 100 towards the front end 190. The first service door 540 may be a pivoting door wherein a vertical edge at the rear end of the first service door 540 comprises hinges 550 such that the first service door 540 opens away from the front end 190. The first service door 540 may allow access to a first subset 500 of components of the power unit 112. The first subset 500 may include a plurality of filler necks (e.g., fluid intakes) and a plurality of fluid tanks as well as a plurality of electrical components. Each of the plurality of filler necks may be positioned in close proximity to each other, increasing efficiency of access during refueling. Centrally locating refueling components may further increase efficiency as each of the refueling components may be accessed from a single service door (e.g., the first service door 540).

In some examples, the first subset 500 comprises the filler neck 416 of the diesel tank, a filler neck 512 of the diesel exhaust fluid tank 420, a hydraulic oil intake 518, a jump start connector point 514, a wiper fluid intake 516, and the hydraulic oil tank 414, as shown in FIG. 5. In some examples, the hydraulic oil tank 414 includes an inspection glass 510 to allow an operator to view a level of oil within the hydraulic oil tank 414, decreasing time spent in accessing the hydraulic oil tank 414 itself when determining whether refill or oil change is demanded. The first subset 500 of components may comprise components that demand frequent maintenance and/or use. Positioning the first service door 540 towards the front end 190 of the tracked vehicle 100 may allow for ease of access to the first subset of components. Further, the first subset 500 of components may be arranged to fit within a package of the front section 536 of the power unit housing 134. As will be further described with respect to FIG. 12, the front section 536 may downslope towards the front end 190 of the tracked vehicle and as such the first subset 500 of components therein may be arranged to fit within the downsloped package design.

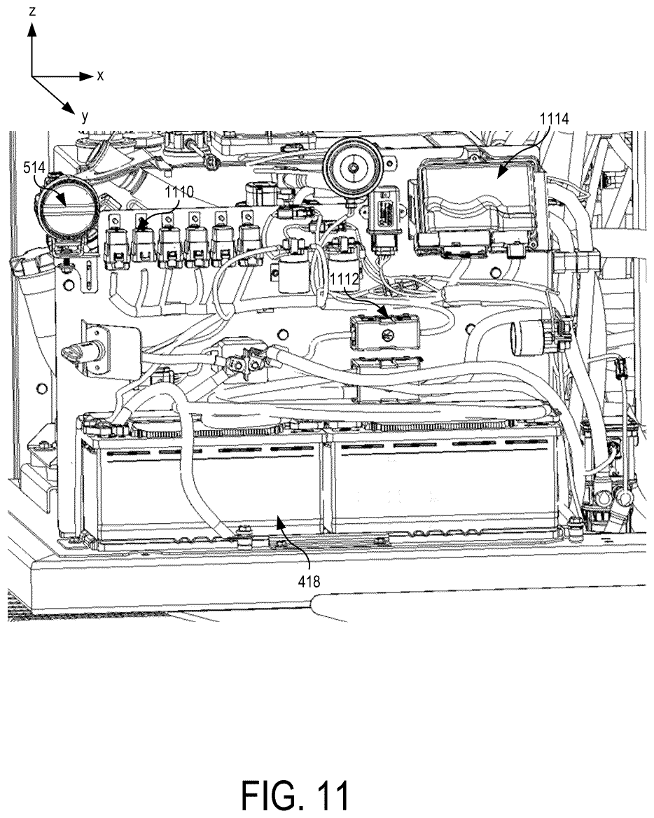

In some examples, at least a portion of the electrical components of the power unit 112 are included in the first subset 500 of components and are accessible via the first service door 540. The electrical components may include the jump start connector point 514 as well as the battery system 418. Additionally, the electrical components of the power unit 112 may include, as shown in FIG. 11, relays 1110, one or more fuses 1112, and a control device 1114. The first service door 540 may provide ease of access to each of the electrical components of the power unit 112. Further, arranging the power unit 112 such that the electrically components are located in a single area may reduce time spent during maintenance or quality checks.

Returning to FIGS. 5 and 6, the first service door 540 may be designed as an irregular shape as shown in FIG. 6, including a portion 610 of the first service door 540 extending in a transverse direction towards the operator cabin 110 when the first service door 540 is closed. The portion 610 of the first service door 540 may also be downsloped to match an angle of downsloping of a front section of the power unit housing 134, as will be described further with respect to FIG. 12. A corresponding cutout 620 of the power unit housing 134 may include a recessed portion 622 in the transverse direction that may allow for visualization of and access to a portion of the first subset 500 of components from above when the first service door 540 is open. The recessed portion 622 of the cutout 620 may also increase the space of the cutout 620, thereby allowing for increased accessed to the first subset 500 of components therein.

As noted, the irregular shape of the first service door 540 is configured to entirely cover the cutout 620, including the recessed portion 622, when the first service door 540 is closed. The recessed portion 622 may have a first width 624. A second width 626 of the portion 610 of the first service door 540 may be equal to or greater than the first width 624 such that the first service door 540 entirely covers recessed portion 622 of the cutout 620. In this way, the first subset 500 of components are covered during operation of the tracked vehicle 100. Further, the irregular shape with a three-dimensional design including the portion 610 may reinforce the first service door 540.

With the top down access provided by the cutout 620, fuel refills for components such as the hydraulic oil tank 414 via the hydraulic oil intake 518 may be made easier and faster. In some examples, the first subset 500 of components accessible from the first service door 540 may be arranged such than intakes, filler necks, and the like that allow for fluid refills, fluid changes, and the like may be accessed when the first service door 540 is open. For example, the filler neck 512 of the diesel exhaust fluid tank 420 and the hydraulic oil intake 518 of the hydraulic oil tank 414 both face outwards (e.g., away from the operator cabin 110) such as to be accessed when the first service door 540 is open.

With respect to FIGS. 7 and 8, the second service door 710 is shown. The second service door 710 may be spaced apart from the first service door 540, positioned behind the first service door 540 and the operator cabin 110 and separated from the first service door 540 by a third service door, as will be further described below. The second service door 710 may allow access to a second subset 700 of components of the power unit 112. In some examples, the second subset 700 comprises filter elements and external power connections. The second service door 710, as a portion of the side portion 152 of the power unit housing 134, may be positioned on the first lateral side 170 of the tracked vehicle 100 towards the rear end 192 of the power unit 112 as shown in FIG. 7. The second service door 710 may be designed as a substantially flat door that when closed aligns with an outer flat surface of the first lateral side 170 of the power unit housing 134. Similar to the first service door 540, the second service door 710 may be a pivoting door, wherein hinges 832 are positioned along a vertical edge of the second service door 710 towards the rear end of the power unit housing 134 such that the second service door 710 opens away from the front end 190.

In some examples, the second subset 700 comprises a plurality of filter components. The second subset 700 may be grouped based on functionality and design such that the components therein are arranged to support the prime mover 320 and/or other components such as the hydraulic system. Grouping filter components together may increase ease of component exchange and/or replacement during service. Components of the second subset 700 may be filter components that demand periodic maintenance, servicing, and/or exchange such as an air filter 810, a fuel pre-filter 814, and an engine oil filter 820, and an engine oil dipstick 812, as well as an external electrical connection 818. A water separator 816 may be coupled to the fuel pre-filter 814 and therefore included in the second subset 700. Similar to the first subset 500 of components discussed with reference to FIGS. 5 and 6, the second subset 700 of components may be arranged such that access points for each of the second subset 700 of components face outwards (e.g., towards the first lateral side 170), increasing ease of access for the operator or a technician during maintenance processes.

The third service door 910, as shown in FIG. 9, may be positioned between the first service door 540 and the second service door 710. The third service door 910 may not overlap with the first service door 540 and may not overlap with the second service door 710. In this way, each of the first, second, and third service doors may be opened independently of the other service doors. Similar to the second service door 710, the third service door 910 may be configured as a flat, pivoting door with hinges 950 positioned at a vertical edge located towards the rear end 192 of the third service door 910 such that the third service door 910 opens away from the front end 190.

The third service door 910 may allow access to a third subset 900 of components of the power unit 112. The third subset 900 of components may comprise one or more cooling system components. A condenser 920 of the cooling system 410 may be fixedly attached to an inner surface of the third service door 910 such that when the third service door 910 is open, the condenser 920 is separated from a combination cooler 922. The combination cooler 922, in some examples, may be positioned on the first lateral side 170 of one or more other components of the power unit 112 that either support or are a part of the cooling system 410 or are independent of the cooling system 410. The combination cooler 922 may comprise a hydraulic cooler 924, a water cooler 926, and a charge air cooler 928, each of which may be coupled to different components of the power unit 112. For example, the charge air cooler 928 may couple directly to the chair air pipe 326 while the hydraulic cooler 924 may couple to one or more hydraulic system components. The combination cooler 922 may be an outermost component of the third subset 900 of components when the third service door 910 is open and the condenser 920 is separated from the combination cooler 922. In this way, ease of access to both the condenser 920 and the combination cooler 922 may be increased.

An outer aspect 1002 of the third service door 910, as seen in FIG. 10, comprises a plurality of ribs 1008 (e.g., slots) of a perforated plate 1006. The plurality of ribs 1008 of the perforated plate 1006 may increase surface area of the perforated plate 1006. As a result of increased surface area, a proportion of open surface of the third service door 910 is increased, thereby reducing resistance for an air volume flow of a fan of the cooling system 410 when the third service door 910 is closed. In this way, the third subset 900 may comprise components that demand airflow as the perforated plate allows for increased airflow into and out of the middle section 534.

As noted, each of the plurality of service doors 136, including the first service door 540, the second service door 710, and the third service door 910 may each be opened independent of the other of the plurality of service doors 136 due to the doors not overlapping with each other. For example, any combination of open and closed doors of the first, second, and third service doors may be feasible. In this way, multiple maintenance and/or service processes may take place concurrently, decreasing time spent during maintenance and/or service processes and increasing efficiency.

Each of the plurality of service doors 136 may be latching doors that, when closed, are locked in place so as to reduce possibility of the doors opening during operation of the tracked vehicle 100. Release of a latch, such as latch 830 of the second service door 710, may unlatch the corresponding door to allow the door to pivot open for access to a respective subset of components therein. In some examples the latch 830 may be a manual latch, such as a cam latch, or an automatic latch that latches automatically upon closing, such as a slam latch.

In the embodiment shown in the figures, each of the plurality of service doors 136 are positioned on the first lateral side 170 of the power unit housing 134 such that the back portion 150 of the power unit housing 134 does not comprise service doors. In this way, the work equipment 230, as shown in FIG. 2, may be mounted atop the chassis 126 behind (e.g., behind the rear end 192 of) the operator cabin 110 without hindering access to any of the plurality of service doors 136.

In other embodiments however, it should be understood that the plurality of service doors 136 may include other service doors in addition to the first service door 540, the second service door 710, and the third service door 910. For example, additional service doors may be included as part of the back portion 150 of the power unit housing 134 at the second lateral side 172 in order to access components such as the exhaust aftertreatment system 310 and/or the prime mover 320.

Turning now to FIG. 12, a lateral view of the tracked vehicle 100 is shown, showing the first lateral side 170 of the tracked vehicle 100. As previously discussed, the side portion 152 of the power unit housing 134 may be partitioned into the front section 536, the middle section 534, and the rear section 632. The front section 536 may comprise the first service door 540, the middle section 534 may comprise the third service door 910, and the rear section 632 may comprise the second service door 710.

The middle and rear sections 534, 632 of the power unit housing 134 may both have a first height 1210 (measured from the ground surface). The front section 536 may downslope at an angle A such that the rear end 192 of the front section 536 has the first height 1210 while the front end 190 of the front section 536 has a second height 1212 (also measured from the ground surface), wherein the second height 1212 is less than the first height 1210. As noted, components of the first subset 500 may be included in the first subset 500 in an arrangement that corresponds with the downsloped design of the front section 536. For example, the battery system 418 may be positioned in front of the hydraulic oil tank 414 (e.g., closer to the front end 190) as the battery system 418 has a smaller package size than the hydraulic oil tank 414 and therefore may fit within the smaller front end of the front section 536.

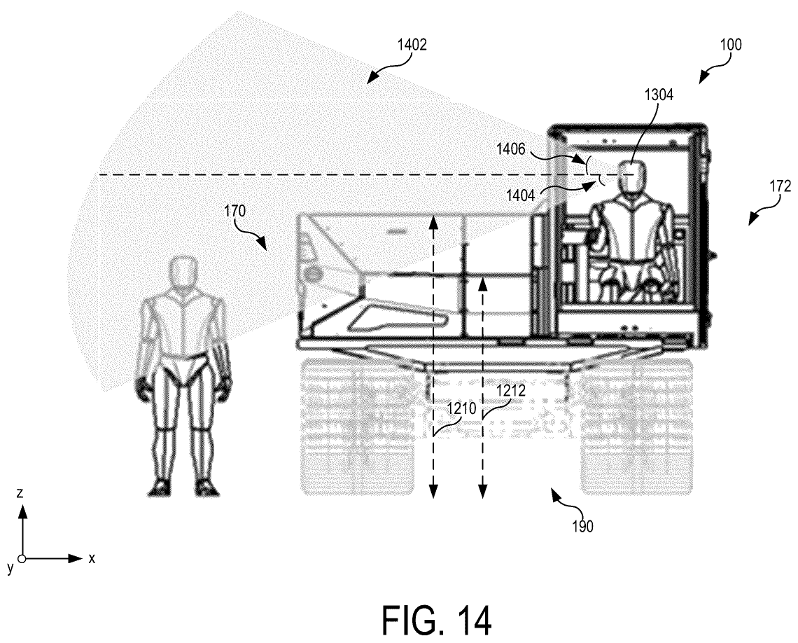

The angle A of the front section 536 of the power unit housing 134 may increase a size of the first lateral side 170 of the lateral facing aspects 133 of the windshield 130 of the operator cabin 110 when compared to if the front section 536 had the first height 1210 at both the rear and front ends. The increased size of the first lateral side 170 of the lateral facing aspects 133 may allow for an increased field of view of the operator sitting within the operator cabin 110, as will be seen with reference to FIGS. 13A and 14.

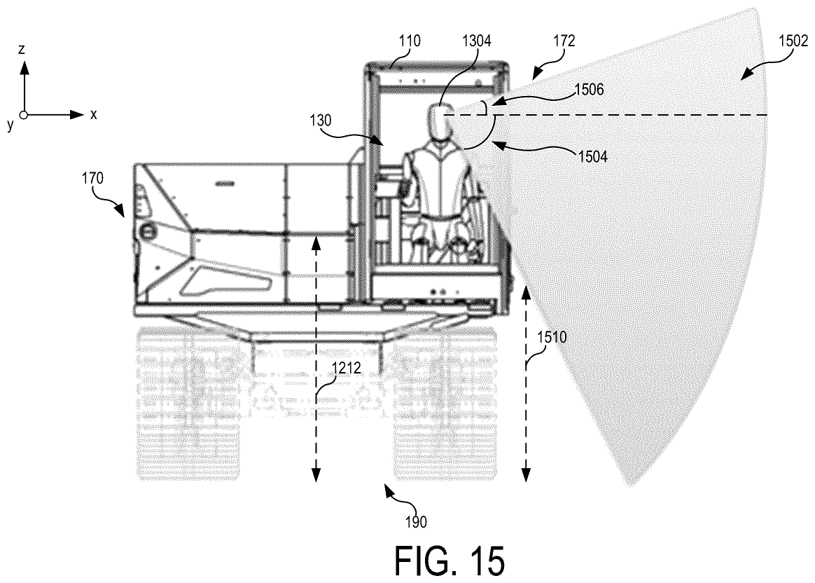

Turning now to FIGS. 13A-15, various perspectives of the field of view of the operator 1304 of the tracked vehicle 100 are depicted. FIG. 13A specifically shows a front facing field of view 1302 from the first lateral side 170; FIG. 13B specifically shows the front facing field of view 1302 from the second lateral side 172; FIG. 14 shows a first lateral field of view 1402 from the front end 190 of the tracked vehicle 100; and FIG. 15 shows a second lateral field of view 1502 from the front end 190 of the tracked vehicle 100. As is further seen in FIGS. 13A and 13B, the operator cabin 110 may comprise a single operator seat 1310 for the operator 1304.

The front facing field of view 1302 may extend a depth based on a depth of the front facing aspect 132 of the windshield 130. The bottom edge of the front facing aspect 132 of the windshield 130, as described with respect to FIG. 1, may extend down to the height 180 from the ground. The height 180 may be less than the second height 1212 such that the bottom edge of the front facing aspect of the windshield 130 is closer to the ground than the top surface of the front section 536 of the power unit housing 134. The height 180 of the bottom edge of the front facing aspect 132 being relatively lower to the ground than the top surface of the front section of the power unit housing 134 may allow for an increased depth angle 1306 of the front facing field of view 1302. Increase of the depth angle 1306 may allow for a larger front facing field of view, which may allow for visualization of more objects, persons, terrain, and/or the like in front of the tracked vehicle 100.

An upward angle 1308 of the front facing field of view 1302 may depend on a height of the operator cabin 110 compared to a height of the operator 1304 sitting within the operator cabin 110. In some examples, the second lateral side 172 of the front facing field of view 1302 may extend downward to a height lower to the ground than the first lateral side 170 of the front facing field of view 1302 as a result of the power unit housing 134 being located on the first lateral side 170 of the operator cabin 110 atop the chassis 126. This is illustrated in FIGS. 13A and 13B by a person 1312 being more in the front facing field of view 1302 from the second lateral side 172 than from the first lateral side 170.

With regard to FIG. 14, the first lateral field of view 1402 is shown. The first lateral field of view 1402 may be a peripheral field of view of the operator 1304 towards the first lateral side 170 (e.g., the right side). Similar to as described with regard to the front facing field of view 1302, a depth angle 1404 of the first lateral field of view 1402 may depend on the second height 1212 of the front end 190 of the front section 536 of the power unit housing 134 and the angle A at which the front section 536 downslopes. The lateral facing aspect 133 of the windshield 130 on the first lateral side is configured to align with the angle A and therefore the first lateral field of view 1402 depends upon the angle A. An upward angle 1406 of the first lateral field of view 1402 may depend on the height of the operator cabin 110 compared to the height of the operator 1304.

The depth angle 1404 may be increased by the second height 1212 being lower to the ground than the first height 1210, thereby increasing a size of the first lateral field of view 1402. The increased size of the first lateral field of view 1402 may allow for visualization of more objects, people, terrain, and/or the like to the first lateral side 170 of the tracked vehicle 100.

With regard to FIG. 15, the second lateral field of view 1502 is shown. The second lateral field of view 1502 may be a peripheral field of view of the operator 1304 towards the second lateral side 172 (e.g., the left side). Similar to as described with respect to the front facing field of view 1302, a depth angle 1504 of the second lateral field of view 1502 may depend on a height 1510 of the second lateral side 172 of the lateral facing aspects 133 of the windshield 130. The height 1510 may be lower to the ground than the second height 1212, which may increase an overall size of the second lateral field of view 1502 allowing for increased peripheral visualization. An upward angle 1506 of the second lateral field of view 1502 may depend on the height of the operator cabin 110 compared to the height of the operator 1304.

A technical effect of the systems of the tracked vehicle as herein described is that efficiency and ease of access to components of the power plant is increased by the plurality of service doors. Each of the plurality of service doors allows access to a respective subset of components of the power unit, and the respective subsets of components are arranged to be accessed via a corresponding service door. Further, an irregular shape of a first service door and corresponding cutout in a power unit housing, wherein the cutout includes a recessed portion along a transverse direction and the first service door comprises a portion that entirely covers the recessed portions allows for access to a first subset of components from above. Further still, a downsloping angle of a front section of the power unit housing allows for an increased side of a lateral facing windshield of an operator cabin, which in turn increases a field of view of the operator, which allows for increased visualization of persons, objects, and terrain that may be encountered by the tracked vehicle.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A tracked vehicle, comprising:
a chassis extending along a longitudinal direction of the tracked vehicle, wherein the chassis comprises a plurality of frame members extending along the longitudinal direction;
an operator cabin coupled to the chassis;
a power unit comprising a prime mover coupled to the chassis and housed within a power unit housing comprising a plurality of service doors, wherein the power unit housing comprises a side portion and a back portion and a front section of the side portion is configured with a downsloping angle; and
a pair of track assemblies in a driving relationship with the prime mover, each track assembly of the pair of track assemblies coupled to one of the plurality of frame members and comprising an endless track disposed around a plurality of wheels; wherein:
each service door of the plurality of service doors is configured to allow access to a respective subset of power unit components.

2. The tracked vehicle of claim 1, wherein the side portion of the power unit housing is positioned to a first lateral side of the operator cabin and comprises the front section, a rear section, and a middle section positioned between the front section and the rear section, wherein a front end of the front section is in line with the front end of the operator cabin and the rear section is positioned to the first lateral side of the back portion of the power unit housing.

3. The tracked vehicle of claim 2, wherein the front section comprises a first service door of the plurality of service doors, the rear section comprises a second service door of the plurality of service doors, and the middle section comprises a third service door of the plurality of service doors, wherein:
the first service door is spaced apart from the second service door via the third service door;
the first, second and third service doors do not overlap along the longitudinal direction of the tracked vehicle; and
each of the plurality of service doors are hinged and configured to open away from the front end of the tracked vehicle.

4. The tracked vehicle of claim 3, wherein the first service door is configured to allow access to a first subset of power unit components, the second service door is configured to allow access to a second subset of power unit components, and the third service door is configured to allow access to a third subset of power unit components wherein:
the first subset comprises a plurality of refueling components and a plurality of electrical components;
the second subset comprises a plurality of filter components and an external electrical connection;
the third subset comprises one or more cooling system components; and
each of the first, second, and third subsets are arranged for access via the first lateral side of the tracked vehicle when a corresponding service door is open.

5. The tracked vehicle of claim 4, wherein each of the first, second, and third subsets of power unit components are arranged to fit within dimensions of a respective section of the power unit housing.

6. The tracked vehicle of claim 3, wherein an outer surface of the third service door comprises a perforated plate comprising a plurality of ribs configured to allow airflow therethrough and a condenser of a cooling system is fixedly attached to an inner surface of the third service door.

7. The tracked vehicle of claim 2, wherein the operator cabin comprises a windshield comprising a front facing aspect and a plurality of lateral facing aspects, wherein a first lateral facing aspect positioned on the first lateral side of the operator cabin is configured to align with the downsloping angle of the front section of the power unit housing.

8. The tracked vehicle of claim 4, wherein the first service door is an irregular shape configured to cover a cutout of the front section of the power unit housing, wherein the cutout comprises a recessed portion extending along a transverse direction of the tracked vehicle.

9. The tracked vehicle of claim 8, wherein the recessed portion of the cutout of the front section of the power unit housing is configured to allow access to at least a portion of the first subset of power unit components from above.

10. A tracked vehicle, comprising:
a chassis extending along a longitudinal direction of the tracked vehicle, the chassis comprising a plurality of frame members extending along the longitudinal direction;
an operator cabin mounted atop the chassis;
a power unit comprising a prime mover mounted atop the chassis behind and to a first lateral side of the operator cabin, wherein the power unit is housed within a housing; and
a pair of track assemblies coupled to the chassis via the plurality of frame members, wherein each track assembly of the pair of track assemblies comprises an endless track disposed around a plurality of wheels, the plurality of wheels comprising a drive wheel spaced apart from an end wheel and a plurality of support wheels positioned between the drive wheel and the end wheel, wherein:
the housing comprises a plurality of service doors including a refueling service door, a filter service door, and a cooling system service door each configured to allow access to a respective subset of components of the power unit; and
a front section of the housing is configured with a downsloping angle.

11. The tracked vehicle of claim 10, wherein the refueling service door is configured to allow access to a first subset of components of the power unit, wherein the first subset comprises a plurality of filler necks for various fluid tanks, wherein the first subset of components is configured to fit within the front section of the housing.

12. The tracked vehicle of claim 10, wherein the refueling service door is included in the front section of the housing, the filter service door is included in a rear section of the housing, and the cooling system service door is included in a middle section of the housing, wherein the refueling service door, the filter service door, and the cooling system service door do not overlap.

13. The tracked vehicle of claim 11, wherein the first subset of components of the power unit further comprises a plurality of electrical components, and the front section of the housing comprises a cutout with a recessed portion configured to allow top down access to at least a portion of the first subset of components.

14. The tracked vehicle of claim 10, wherein the filter service door is configured to allow access to a second subset of components of the power unit and the cooling system service door is configured to allow access to a third subset of components, wherein the second subset comprises a plurality of filters and the third subset comprises one or more cooling system components.

15. The tracked vehicle of claim 10, wherein the operator cabin comprises a windshield and an operator seat with a single seat position, wherein the windshield comprises a front facing aspect and a plurality of lateral facing aspects, wherein a first lateral facing aspect arranged on the first lateral side is configured to align with the downsloping angle of the front section of the housing of the power unit.

16. A tracked vehicle, comprising:
a chassis extending along a longitudinal direction of the tracked vehicle and comprising a frame, wherein the frame comprises a plurality of frame members, a first frame member arranged on a first lateral side and a second frame member arranged on a second lateral side;
an operator cabin coupled to and positioned atop the chassis;
a power unit comprising a prime mover and coupled to and positioned atop the chassis, wherein the power unit is housed within an enclosure comprising a plurality of service doors arranged on the first lateral side of the enclosure; and
a pair of track assemblies coupled to the frame, wherein a first track assembly is coupled to the first frame member and a second track assembly is coupled to the second frame member, wherein each of the pair of track assemblies comprises an endless track disposed around a plurality of wheels, the plurality of wheels comprising:
a drive wheel in a driving relationship with the prime mover;
an end wheel spaced apart from the drive wheel along the longitudinal direction of the tracked vehicle; and
a plurality of support wheels arranged between the drive wheel and the end wheel along the longitudinal direction and spaced apart from the end wheel; wherein:
the plurality of service doors comprise a first service door configured as part of a front section of the enclosure, a second service door configured as part of a rear section of the enclosure, and a third service door configured as part of a middle section of the enclosure;
each of the first, second, and third service doors are configured to allow access to a respective subset of power unit components; and
the front section of the enclosure is downsloped with respect to the rear and middle sections.

17. The tracked vehicle of claim 16, wherein the first service door is configured to allow access to a first subset of power unit components, the first subset of power unit components comprising components of a hydraulic system and a plurality of electrical components.

18. The tracked vehicle of claim 16, wherein the second service door is configured to allow access to a second subset of power unit components, the second subset of power unit components comprising a plurality of filters.

19. The tracked vehicle of claim 16, wherein the third service door is configured to allow access to a third subset of power unit components, the third subset of power unit components comprising one or more cooling system components, wherein the third service door is affixed to a condenser of the cooling system.

20. The tracked vehicle of claim 17, wherein the first service door is irregularly shaped and configured to cover a cutout of the front section of the enclosure, wherein the cutout comprises a recessed portion configured to allow top down access to the first subset of power unit components.
